(19) United States
(12) Patent Application Publication
(10) Pub. No.: US 2002/0120558 A1
(43) Pub. Date: Aug. 29, 2002

(54) System for managing risks by combining risk insurance policy investments with risk prevention computer-based technology investments using common measurement methods

(76) Inventor: William Joseph Reid, Dallas, TX (US)

Correspondence Address: NETP&L, INC., 7819 PENCROSS LANE, DALLAS, TX, 75248, US

(21) Appl. No.: 09/752,764

(22) Filed: Feb. 27, 2001

(51) Int. Cl. G06F 17/60

(52) U.S. Cl. 705/38

(57) ABSTRACT

A system to translate and express a company's e-business risk in dollars and to then compare investment alternatives in computer-based risk technology and risk insurance policy coverage to achieve the most favored risk management. This most favored risk management is a combination of computer-based risk technology and risk insurance policy coverage determined by the risk reduction potential of each type of investment. The system provides the means of comparing investment costs of risk prevention computer-based technology with one or more risk insurance policies.

### FIELD OF THE INVENTION

The present invention relates to risk management of a Company's assets from all manners of threats to computer-based systems.

### BACKGROUND OF THE INVENTION

The e-business world has created unique risk and loss potentials that are like nothing companies have ever experienced. Companies are now realizing that if their computer-based information system becomes the point of compromise of assets like customer records, product plans or networked computers, they have a fiduciary responsibility to protect their corporate stakeholders at all cost.

For example:

1. Customers: If the company users release sensitive customer information, how can the company be damaged? What will be the impact on the customer relationship going forward?

2. Suppliers/Vendors: If a hacker uses a Company's networked computers to attack a supplier, how will they respond? Will they initiate a retaliation attack? How will the relationship survive?

3. Executives/Board of Directors: If hackers launch a denial of service attack against corporate identity websites what will be the cost of embarrassment and humiliation to a Company's board of directors and corporate executives? How will they shoulder the responsibility for e business interruption?

4. General Public: If users on a company's computer system send out malicious code, what will be the impact on the rest of the Internet? How could a company's computer user's e-business activities harm innocent users in this country and around the world?

Highlights of the 2000 CSI/FBI Computer Crime and Security Report demonstrate the computer-based technology risk comprising:

1. Network security breaches hurt the bottom line. Of the respondents who admit suffering a security breach, there was significant business operations interruption and loss of reputation on top of the financial losses. 52% of the respondents said their company's state of computer-based security is average or below and 35% claim that security doesn't have high visibility.

2. Corporate security breach is on the rise. The number of companies hit by an unauthorized access (hacking/cracking) breach increased nearly 92% from 1997 to 1998. There is no such thing as a completely secure computer network. 90% of the respondents suffered breaches to their computer networks within the past year.

3. e-Business activities make companies a bigger target. The companies reporting these breaches were primarily large corporations and government agencies. Companies conducting business online are 57% more likely to experience a proprietary information leak and 24% more likely to experience a hacking-related breach.

4. New Internet exposures threaten company's networks. There is an accident waiting to happen if companies do not monitor e-business security. 32% of the respondents reported that they did not know if there had been unauthorized access or misuse of their computer network. Hackers/crackers (21%), malicious code (17%), e-mail (15%) and secure remote access (14%) are claimed to be the greatest source of concern and 77% of respondents had suffered losses from virus attack.

5. Internal users are just as risky as outsiders. 71% of the respondents reported unauthorized access by those within the organization. 74% of the respondents reported financial losses stemming from breach of computer security. 273 organizations that were able to quantify their losses reported a total loss of $265,589,940. Reported theft of proprietary information resulted in losses totaling $66,708,000 for 66 respondents.

E-business losses may cause a company direct damage (First Party) or liability claims (Third Party). Either way, in the networked e-business world a security breach within an computer-based system may cause untold damage to others who are linked to, and depends, on a Company's stability. The e-business risks will easily be become the largest category of risk for many companies, far larger than fire, flood, sexual harassment and the many other risks normally hedged by insurance.

### BACKGROUND—DISCUSSION OF PRIOR ART

In prior art insurance is thought of as a primarily as a hedge. In both our personal life and in our businesses we typically invest in the things that we know of to make us safe and then use insurance for a hedge against the unlikely events that cannot be forecast. What is different in new information economy, as companies face the e-business risk, is the size of the decisions. E-business risks can be 100's of millions of dollars and risk prevention computer-based technology investments can be in the 10's of millions of dollars. Technology alone cannot eliminate all the computer-based financial risk that a company will face in the e-business economy. Significant risk must still be managed beyond what technology solutions can provide. To manage this risk insurance will no longer be a hedge it will be an investment.

In prior art of computer-based technology the company's information systems operation makes investments in risk reduction computer-based technologies to try to eliminate, anticipate or mitigate these new and growing e-business risks. They have no knowledge of how to evaluate these computer-based technology decisions based on risk, nor do they know how to express computer-based technology decision's risk in dollars. Technologists have no experience with risk insurance so they don't know the costs or the coverage of such policies or product offerings.

The present invention provides superior risk management by integrating both of the prior art discipline of risk insurance and the prior art discipline of risk prevention computer-based technologies in such a system that each risk reduction discipline can benefit from knowledge of the other. This benefit is not possible in the prior art where risk insurance and risk prevention computer-based technology disciplines are independent from each other.

The presence invention teaches that we can express risk in dollars. This teaching is uncommon in the prior art of insurance and in the prior art of computer-based technology. The first step of integrating insurance and computer-based technology is developing a common language of risk. That language is dollars. Using that teaching we can depict risk reduction computer-based technology investments in dollars as illustrated in FIG. 1.

In FIG. 1 the vertical axis is investment dollars for computer-based risk reduction solutions and the horizontal axis are risk dollar estimates that may justify these investments. Risk may be thought of as a loss of asset value for the company's computer-based assets. Of significance FIG. 1 shows that the computer-based technology investment to eliminate all risk is infinite (on the left side of FIG. 1 where risk dollars approach zero) for a company that is committed to e-business connections to customers and suppliers. At risk assets are both the physical assets and intellectual property assets. Risk expresses a value reflecting the cost of damage to these assets resulting from losses of confidentiality (i.e. disclosure), integrity (i.e. unwanted modification) or availability (i.e. unavailability or denial of service).

An example was the hacking of Microsoft in November of 2000 where the computer-based intellectual property loss could have been a significant portion of the entire market value of the Microsoft. Microsoft is a nearly 100% computer-based intellectual property company so it had a lot to lose. In today's information age all companies are becoming computer-based intellectual property companies so they too will have a lot to lose.

Looking at the computer-based technology risk curve as shown in FIG. 1 we can also see that in the vicinity where the dollars invested in risk reduction computer-based technology becomes asymptotic to the vertical axis (the knee of the curve) high investment dollars generate small risk reductions.

FIG. 2 shows, with the same axes as defined in FIG. 1, the investment in insurance policies to eliminate the risk expressed. Of significance, insurance is very expensive to cover a high amount of risk but as the risk gets lower the investment in insurance will becomes less. Insurance is typically a policy amount covering specific occurrences, a deductible loss amount before claims can start, and an annual fee.

FIG. 3 illustrates that by overlaying the computer-based technology risk reduction investment and the insurance risk reduction investment that there is an intersection below which insurance is a less costly investment than computer-based technology to reduce risk.

In FIG. 4 we see an investment strategy that may illustrate the best risk management profile for a Company.

### SUMMARY

The present invention is the system elements to integrate the prior art disciplines of risk insurance and risk reduction computer-based technology in a new system to provide superior risk management. System elements integrate the prior art disciplines of risk insurance and risk reduction computer-based technology to put both these disciplines into a common risk measurement format. The format that will be used to express both the prior art disciplines of risk insurance and risk reduction computer-based technology will be dollars of risk ($Risk) and dollars of investment ($I) to provide the means of comparing investment costs of risk prevention computer-based technology with one or more risk insurance policies.

### OBJECTS AND ADVANTAGES

If we look at the computer-based intellectual property risk a company faces we see two general categories 1) security breaches and 2) fraud. These two categories have been nearly equal in percent of occurrences but traditionally fraud has a much higher risk in our dollar measurement. An institution generally has computer-based technology in a network to support the users of the institution. But the institution's business is normally done a series of transactions. Looking then at the two general categories of risk identified above, security breaches happen at the computer-based network level, fraud happens at the computer-based transaction level.

At the network level computer-based risk prevention technology has been applied but not insurance. We can generally find the investment dollars required to implement the known risk mitigation computer-based technologies in the information systems budget. The present invention is the system elements to express computer-based technology investments in risk coverage dollars by categorizing the computer-based technology investments that made transaction flow. For example, the transaction may be an energy trade by a public utility. A utility employee may log into the trading system on the Internet with a user name and password. Finding the correct information, the employee initiates a trade; a trade confirmation is confirmed on the web and then may be e-mailed to the employee.

After a settlement period funds are electronically transferred from the utility to the trading system account. Electronic records of this trade are provided monthly from the trading company to the utility and processed on the utility computer system into the accounting system. In this case we may choose the employee logging in over the Internet is the initiation of the transaction and when the records are entered into the accounting system as the end of the transaction. The operations of the accounting systems may be other transactions.

Step 502 then illustrates how this knowledge of the transaction flow allows the calculation of the loss potential in assets affected by the transaction. For example, in our utility trade of Step 501 the assets affected were, of course, the cash of the utility to settle the trade. But also if the trade were bogus it would affect the relationship between the utility and the trading company. It could also impact the good name of the utility; in a competitive, deregulated environment this could be the company's highest valued asset. Failures could also propagate into the financial records that may be difficult and costly to reconcile, creating a reduced value to those assets.

Step 506 of FIG. 5 is a conventional network vulnerability assessment performed by either an internal organization or by an external organization such as Internet Security Systems of Atlanta, Ga. This assessment will establish a baseline value for the Company's risk from external penetration of the institution's network.

This assessment includes identifying weaknesses in the actual or potential physical environment, organization, procedures, personnel, management, administration, hardware, software or communications equipment, that may be exploited by a threat source to cause harm to the assets, and the business they support. The presence of vulnerability does not cause harm in itself, as there must be a threat present to exploit it. A vulnerability, which has no corresponding threat, does not require the implementation of a countermeasure. It should be noted that an incorrectly implemented or malfunctioning countermeasure, or a countermeasure being used incorrectly, could in itself be vulnerability.

Step 507 analyzes the computer-based technology risk investments that are in progress and budgeted and also determines future information systems risk reduction investments that can be made. These investments have normally been planned by the information systems department or by the information security department of the company such that the cost of the investment has been determined in the budgeting process. Often the budgeted information computer-based technology cost is not the total cost as these technologies affect the productivity of other parts of the institution so additional work must be done to generate the true investment. In the vulnerability assessment of Step 506 other computer-based risk technologies may be identified such that the new investment in these technologies will have to be determined.

Step 503 of FIG. 5 obtains quotes or estimates for both the potential IT risk reduction computer-based technology investments and for the insurance policy coverage that have been determined from the vendors of those investments. As was mentioned in Step 507 the computer-based technology investments can be obtained from the institutions budgeting process. For computer-based technology investments not yet budgeted an estimate may be used.

Computer-based technology investments and insurance investments are generally not in the same structure or coverage from a risk perspective. Insurance covers “Wrongful Acts” that generally occur in Technology Errors or Omissions, Media or Intellectual Property Offenses and Breach of Computer Security of the “Selected Network”. Risk reduction technologies will be access control, server certificate, client services, client software, etc. Step 503 then develops the associations between the structure of insurance products and computer-based technology products. At this there has been efforts to associate computer-based technology and insurance but the investments are still largely independent.

Step 510 of FIG. 5 then develops the integration of the computer-based technology and insurance products by portraying to the insurance underwriters the exact nature of the risk to be covered by a set of technologies selected for implementation. There may be more than one set of insurance products and computer-based technology sets that will then be developed into alternative risk profiles that the Company may use.

These alternatives may take the form of FIG. 4. This will be an interactive process in which both the insurance and computer-based technology investments are integrated into one or more potential solutions.

For example, many companies are planning to replace username/password systems with public key infrastructure (PKI) systems. PKI may significantly decrease the risk and therefore decrease the cost of insurance but PKI may be a very expensive computer-based technology investment. However, PKI offers many alternatives so this too will be an interactive process with insurance coverage. The insurance companies will have far greater knowledge of the risks they are covering, the technologists will be able to invest in technologies that have high risk reduction and leave low probability risks to insurance.

At Step 520 the institution has selected a risk mitigation plan that produces an acceptable level of risk for the company. In this step this information may be used to develop the plans for implementation of both the computer-based technology selected and for the insurance products and coverage selected.

FIG. 6 shows an example of how risk mitigation technologies have been used in risk management. On the far right of FIG. 6, until recently most on the information representing computer-based intellectual property was on mainframe computers. RACF (Remote Access Control Facility) was the IBM product that secured that information. As we moved into remote access with laptop computers and work-at-home employees we needed firewalls to control remote access. Then e-mail became the way of business communication and virus protection and monitoring was needed. Putting up web sites for both customer and employee communication was next and access control products like Netegrity, Inc 52 Second Ave, Waltham, Mass. 02451 or Securant, Inc. 1 Embarcadero Center, Lobby 5 San Francisco, Calif. 94111 were needed. Of course, the risk dollars are time sensitive also. The amount of risk that is still under the control of RACF has probably decreased as applications have moved off the mainframe. In the other direction certainly the e-mail threat and risk has greatly increased.

Now companies want to replace dedicated connections with the public Internet for all communication and Public Key Infrastructure (PKI) is becoming the computer-based technology of choice for security. As you might expect as we have moved from right to left on FIG. 6 the technologies have become more expensive but have also covered a smaller part of the entire risk profile. As you might expect from the name “public key infrastructure” is expensive and already be implemented, scheduled for implementation or represent a possible future investment. Nearly all-external risks are present at the computer-based network level. The risk of private industries becoming the target of a terrorist attack is increasing. As governmental assets become privatized, as industries explore new endeavors, and as data availability throughout the World Wide Web becomes more widespread, the “target list” of possible terrorist victims grows longer and longer. External reference material, like the 2000 CSI/FBI Computer Crime and Security Report, are used to provide the basis for risk estimates for computer-based technology investments.

For fraud management we generally see access control technologies applied and we are just starting to see some insurance products provide risk coverage in this area. As defined by the present invention companies have no way of correlating computer-based technology investments and insurance investments so they are independent decisions generally handled by separate company organizations. Fraud happen at the transaction level so the present invention expresses a Company's transaction risk in dollars by categorizing the Company's transactions and determining the transaction's effect of the Company's assets. Under the present invention risk then would represent the decrease in asset value in the Company's currency from weaknesses in transaction security anywhere in the transaction flow.

The present invention teaches how risk to the company's computer-based intellectual property can be expressed as dollars. Insurance and computer-based technologies are both investment categories in dollars. Combining of these investments versus risk in dollars show how the present invention provides a superior result in risk management.

### BRIEF DESCRIPTION OF THE DRAWINGS

FIG. 1 illustrates the prior art of computer-based technology investment versus risk.

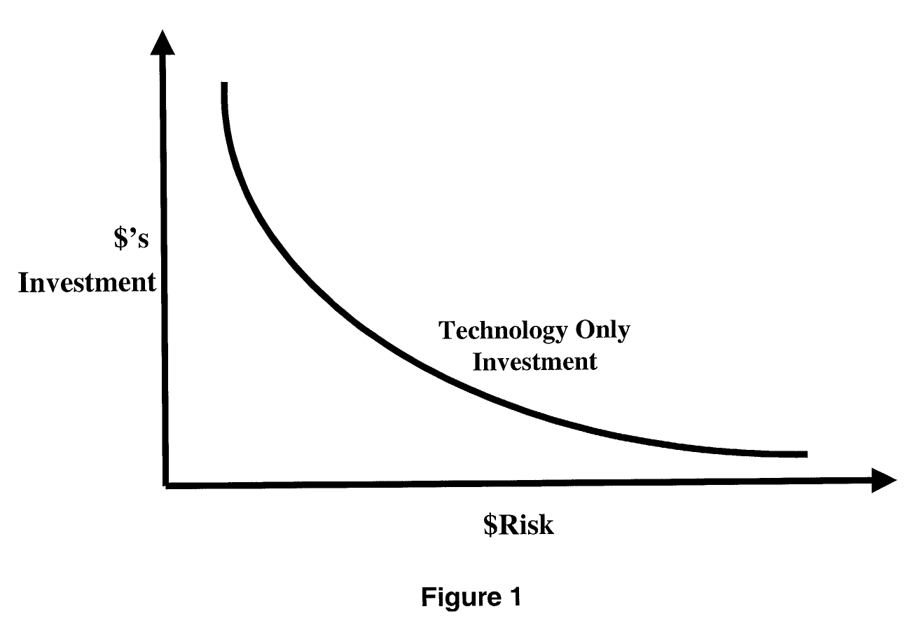

FIG. 2 illustrates the prior art of insurance investment versus risk.

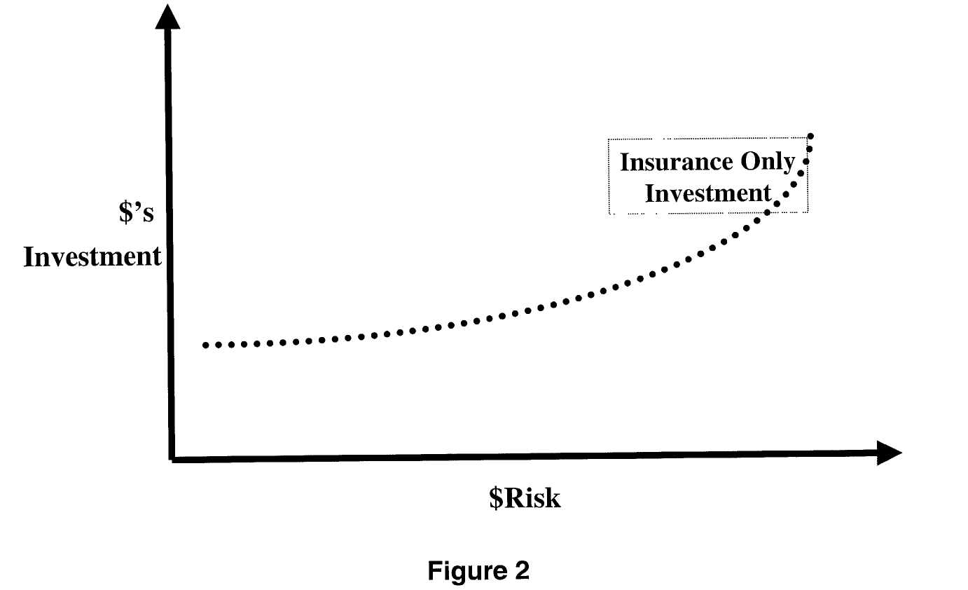

FIG. 3 illustrates a combination of insurance investment and computer-based technology investment versus risk.

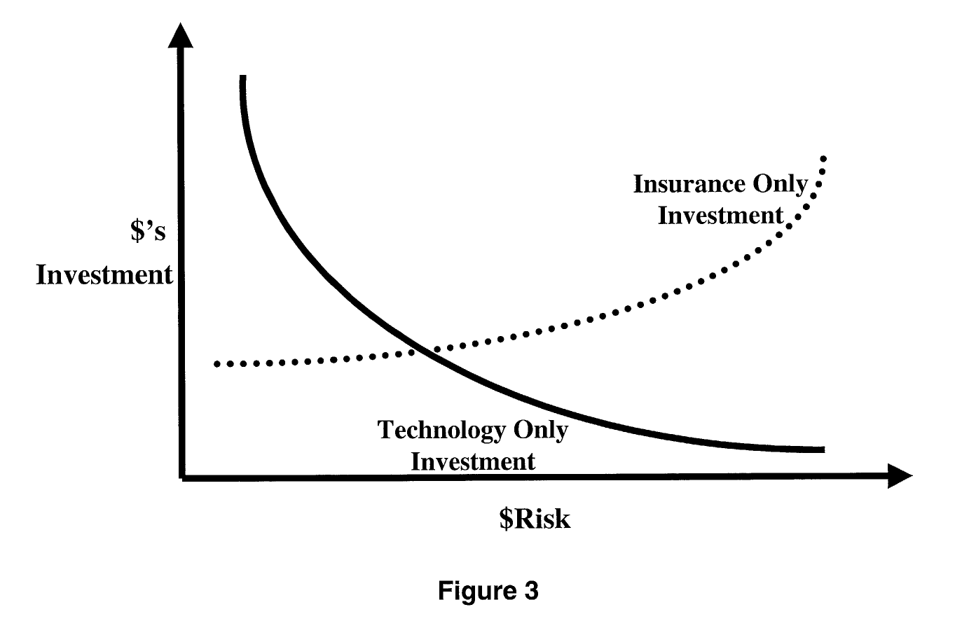

FIG. 4 illustrates a best investment case for risk management.

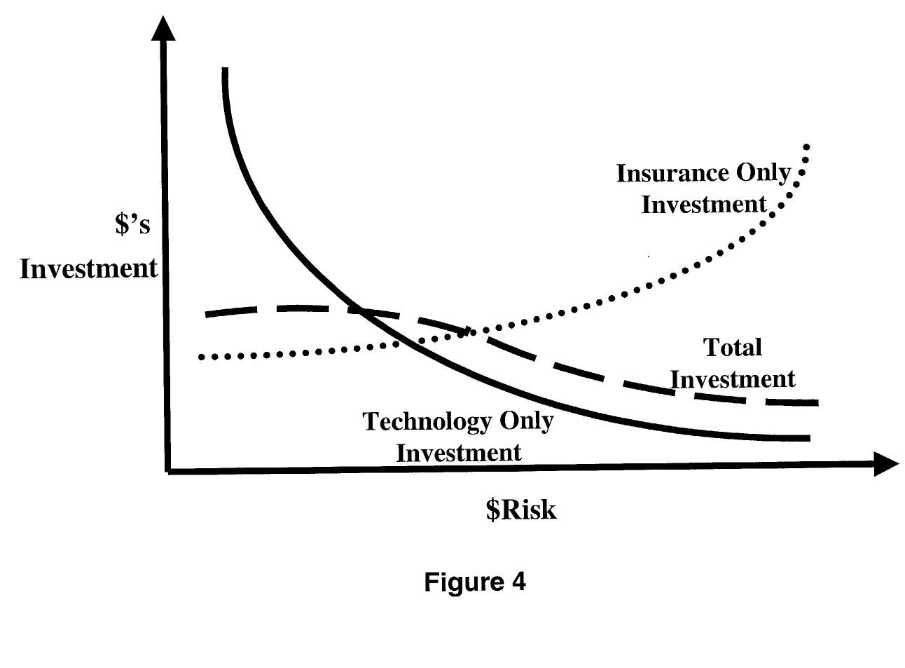

FIG. 5 illustrates a possible functional flow of the combination on the system elements.

FIG. 6 illustrates an example of computer-based technology investment versus risk.

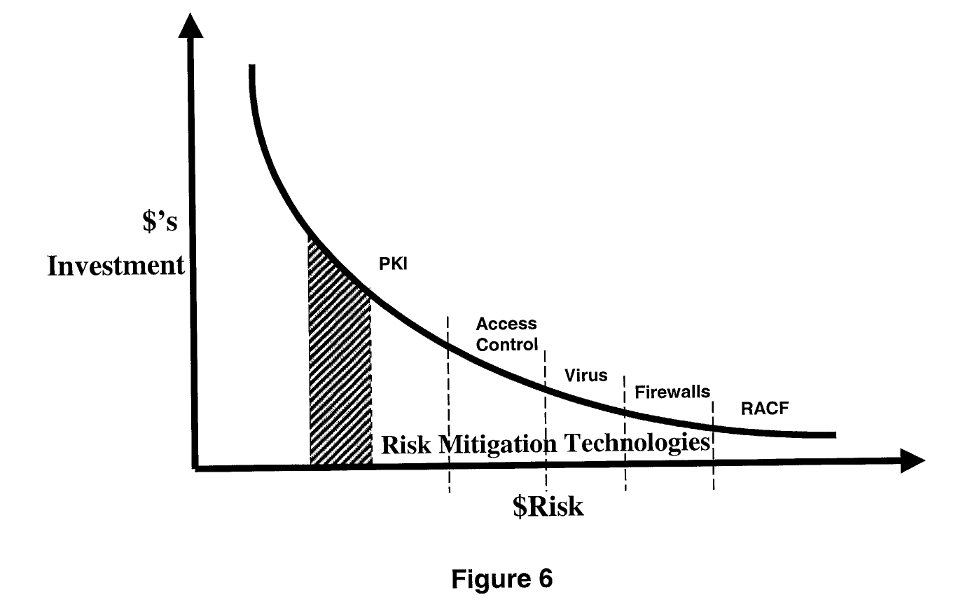

FIG. 7 illustrates an example of combination of insurance investment and a best investment case for risk management.

### DESCRIPTION OF INVENTION

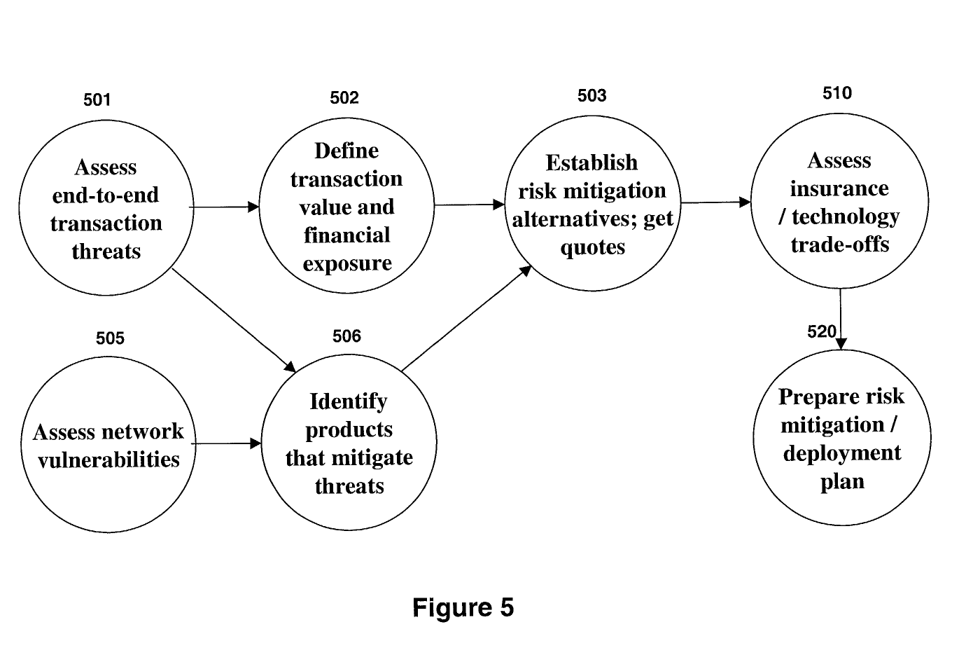

FIG. 5 shows a preferred system functional flow of the present invention.

Step 501 in FIG. 5 illustrates that a Company's transactions are gathered and categorized representing the transaction flow from transaction creation to transaction completion or what may be called end-to-end has a very broad set of capabilities as alternatives for investment. For a large company it might be typical that a base PKI investment might be $10M with $15M of alternatives.

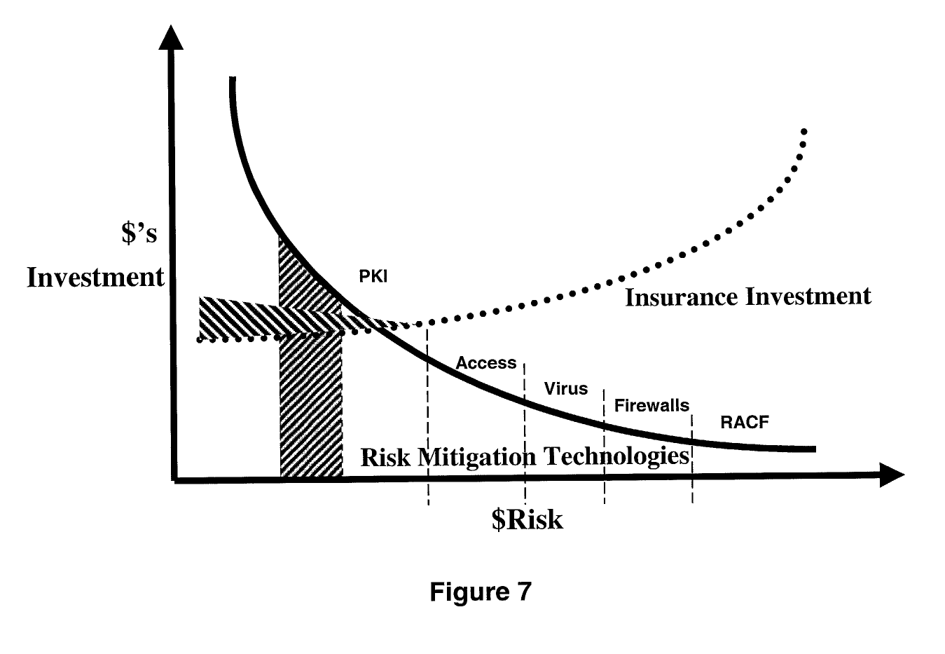

FIG. 7 illustrates how the risk insurance investment intersects with the risk mitigation computer-based technology investment curve. Just as PKI has a broad range of alternatives, risk insurance will have corresponding broad range of policy options. Using the system elements of the present invention the institution is able to objectively compare the alternatives in risk computer-based technology and risk insurance.

The present invention teaches how risk to the company's computer-based intellectual property can be expressed as dollars. Insurance and computer-based technologies are both investment categories in dollars. Comparisons of these investments versus risk in dollars show how the present invention provides a superior result in risk management.

What is claimed is:

1. A method for achieving a most favored risk management using a computer-based system comprising:
a) Means of providing risk management insurance policy coverage of at least Breach of Computer Security of the “Computer-Based System”.
b) Means of comparing investment costs of risk prevention computer-based technology with one or more risk insurance policies.

2. A method of risk management that provides investment comparison of insurance and computer-based technology alternatives comprising:
a) Means of expressing risks to Company assets in common currency.
b) Means of expressing risk coverage of one or more computer-based technologies into common currency.

3. A method of risk management that expresses risks to company assets in common currency comprising:
a) Means of analyzing a Company's transactions and their corresponding effect on a Company's assets and expressing that risk in common currency.
b) Means of determining the flow of a Company's computer-based transactions and ranking them by risk expressed in common currency.

4. A method of expressing risk coverage of one or more computer-based technologies into common currency comprising:
a) Means of establishing a baseline of network risk though a vulnerability study.
b) Means of expressing computer-based technology investment risk in terms of common currency by estimating of at least one of the following:
(1) Number of people creating the risk.
(2) The policy that can be developed and enforced in this risk area.
(3) The value of the computer-based intellectual property available to this risk area.
